(19) United States
(12) Patent Application Publication
(10) Pub. No.: US 2021/0341080 A1
(43) Pub. Date: Nov. 4, 2021

(54) DEVICE FOR ASSISTING IN MOVEMENT OF A CYLINDRICAL BODY

(71) Applicant: Wayne Tonelli, Iron Bridge (CA)

(72) Inventor: Wayne Tonelli, Iron Bridge (CA)

(21) Appl. No.: 17/038,854

(22) Filed: Sep. 30, 2020

(30) Foreign Application Priority Data
Apr. 30, 2020 (CA) 3,079,870

(51) Int. Cl. F16L 3/02; B65D 63/18

(52) U.S. Cl. CPC F16L 3/02; B65D 63/18

(57) ABSTRACT

Disclosed is a device for assisting in movement of a cylindrical body. The device has a curved band dimensioned to encircle a portion of the cylindrical body; two handles connected to the curved band; and attachment points provided at both ends of the curved band for connecting to a strap. The device disclosed herein allows for a cylinder to be moved without undue stress being on a user's back. Also disclosed are kits containing the device, as well as methods of using the device to move a cylindrical body.

### FIELD OF THE INVENTION

The present invention generally relates to devices that can be used to assist in moving heavy or awkwardly shaped bodies. More specifically, the present invention relates to a device for assisting in moving a cylindrical body, such as a hot water tank or gas cylinder.

### BACKGROUND OF THE INVENTION

Injuries to the back are one of the most common causes of lost work days and workplace injuries. Many occupations require the lifting of awkwardly shaped and heavy objects. It is often the trouble of trying to get a safe and secure grasp of that object that causes a person to position themselves in a manner that puts stress on the muscles of the back, which inevitably leads to injury.

Those working in the field of heating, ventilation and air conditioning (HVAC) are particularly susceptible to back injuries, as these workers are often being required to move awkwardly shaped objects from the basements of people's homes. In particular, due to the size and shape of residential hot water tank, replacing these vital components of a house poses a persistent risk to those working in the HVAC field.

Typically, a hot water tank is removed from a dwelling by two workers grabbing around the ends of tank and walking it out of the dwelling. The shape and weight of these tanks makes it difficult to carry. Moreover, if all the water has not been removed from the tank, then the movement of the water within the tank will constantly change the weight distribution. Furthermore, in North America, most hot water tanks are kept below grade, which requires the workers to navigate stairs to remove such an article from a house.

Since hot water tanks are prevalent in most houses and require replacement from time to time, they are responsible for a majority of the back injuries experienced by workers in the HVAC industry. However, many dwellings, such as those having a residential well, will also have additional objects in their utility rooms that potentially cause injuries to those who are sent to replace them. For example, for homeowners that have a residential well, they will likely have a number of tanks to purify the water from the well. The shape, size and weight of these tanks also present a workplace hazard to those that have to move them.

Previous attempts to develop handles or the like to assist the movement of such awkwardly shaped objects have been made. However, often these devices are designed to move cube-shaped objects, such as clothes washers, dryers, dishwashers, and the like. As such, they are not very effective in moving objects that have curved surfaces, such as cylinders. Moreover, several of these previous attempts require holding the handle against the object and tightening a strap around the handle and object. This can be awkward for a person to do by themselves, and also makes for a potentially unsafe system, as it is possible that the handle can slide out from underneath the strap during movement of the object.

Therefore, there is a need for a reliable and safe device that can be conveniently attached to a cylindrical object.

### SUMMARY OF THE INVENTION

According to one aspect of the present invention there is provided a device for assisting in movement of a cylindrical body. The device comprises: a curved band dimensioned to encircle a portion of the cylindrical body; two handles connected to the curved band; and attachment points provided at both ends of the curved band for connecting to a strap.

In one embodiment, each of the two handles comprise at least a curved band engagement section, an intermediate section and a grip section. The curved band engagement section being substantially parallel to the grip section and the intermediate section being substantially perpendicular to the curved band engagement section and the grip section. In some cases, the curved band engagement section is dimensioned to extend beyond an end of the cylindrical body. In other cases, the intermediate section projects towards the centre of the cylindrical body. The grip section can covered with a material to facilitate grasping of the handle by a user.

In another embodiment, each of the two handles projects away from and substantially perpendicular to the curved band.

In a further embodiment, the two handles are dimensioned to extend beyond an end of the cylindrical body.

In a still further embodiment, the two handles are permanently connected to the curved band.

In yet a further embodiment, the two handles are removable from the curved band.

In one embodiment, the curved band further comprises at least two couplers attached thereto for connecting of a corresponding handle. In some cases, the handles are frictionally engaged with the couplers.

In another embodiment, the attachment points are eyelets for receiving hooks associated with the strap. In a further embodiment, the attachment points are ratchets for receiving the ends of the strap. In a still further embodiment, the attachment points are hooks for receiving rings associated with the strap.

In an embodiment, the curved band is semi-circular.

In a further embodiment, the curved band is made of a semi-rigid material.

In another embodiment, the curved band is segmented to allow for the length or arc of the curved band to be adjusted. In some cases, the curved band comprises three segments and the two end segments move independently with respect to the center segment. In a further embodiment, a locking mechanism is provided on the curved band to prevent movement of the segments with respect to one another.

According to another aspect of the present invention, there is provided a kit for assisting in movement of a cylindrical body. The kit comprising: at least one curved band dimensioned to encircle a portion of the cylindrical body, the curved band having attachment points provided at both ends for connecting to a strap; and at least two handles for connecting to the curved band.

According to a further aspect of the present invention, there is provided a kit for assisting in movement of a cylindrical body. The kit comprising: at least one device as described above comprising: a curved band dimensioned to encircle a portion of the cylindrical body; two handles connected to the curved band; and attachment points provided at both ends of the curved band for connecting to a strap.

In one embodiment, the kit further comprises at least one strap for connecting to the attachment points of the curved band.

According to another aspect of the present invention, there is provided a method of moving a cylindrical body using the device as described above. The method comprising the steps of: abutting a first device against one end of the cylindrical body; attaching a first strap to the first device so that the first device and first strap encircle the cylindrical body; tightening the first strap around the cylindrical body; abutting a second device against the other end of the cylindrical body; attaching a second strap to the second device so that the second device and second strap encircle the cylindrical body; tightening the second strap around the cylindrical body; grasping the handles of the first and second devices; and lifting the cylindrical body to move the cylindrical body.

In one embodiment, the method further comprises the step of adjusting the length or arc of the curved band of the first device to encircle a portion of the cylindrical body prior to abutting the first device against the cylindrical body.

In another embodiment, the method further comprises the step of adjusting the length or arc of the curved band of the second device to encircle a portion of the cylindrical body prior to abutting the second device against the cylindrical body.

According to a further aspect of the present invention, there is provided a method of moving a cylindrical body using the device as described above. The method comprising the steps of: attaching a first strap to the first device so that the first device and first strap are capable of encircling the cylindrical body; encircling one end of the cylindrical body with the first device and the first strap; tightening the first strap around the cylindrical body; attaching a second strap to the second device so that the second device and second strap are capable of encircling the cylindrical body; encircling one end of the cylindrical body with the second device and the second strap; tightening the second strap around the cylindrical body; grasping the handles of the first and second devices; and lifting the cylindrical body to move the cylindrical body.

In one embodiment, the method further comprises the step of adjusting the length or arc of the curved band of the first device to encircle a portion of the cylindrical body prior to encircling the cylindrical body with the first device and the first strap.

In another embodiment, the method further comprises the step of adjusting the length or arc of the curved band of the second device to encircle a portion of the cylindrical body prior to encircling the cylindrical body with the second device and the second strap.

According to a further aspect of the present invention, there is provided a use of the device as described above for moving a cylindrical body.

In one embodiment, the cylindrical body is a hot water tank.

### BRIEF DESCRIPTION OF THE DRAWINGS

These and other features, aspects, and properties of the present invention will become better understood with regard to the following description and accompanying drawings, wherein:

FIG. 1 shows an example of the device as described herein in its operative environment;

FIG. 2 shows one embodiment of the curved band of the device as described herein;

FIG. 3 shows another embodiment of the curved band of the device as described herein;

FIG. 4 shows a further embodiment of the curved band of the device as described herein;

FIG. 5 shows one embodiment of the handles used with the device as described herein;

FIG. 6 shows another embodiment of the handles used with the device as described herein;

FIG. 7 shows a further embodiment of the handles used of the device as described herein; and

FIG. 8 shows one embodiment of the attachment points of the device as described herein.

### DESCRIPTION OF THE INVENTION

Described herein are devices for assisting in movement of a cylindrical body. It will be appreciated that embodiments and examples are provided for illustrative purposes intended for those skilled in the art, and are not meant to be limited in any way.

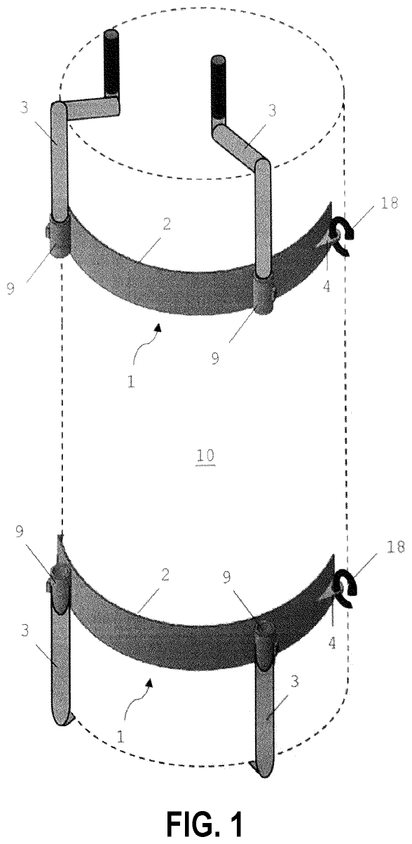

As shown in FIG. 1, the devices disclosed herein can be used to assist in the lifting and movement of cylindrical bodies, such as, but not limited to, hot water tanks, gas cylinders, water filtration cylinders and softeners. The device (1) comprises a curved band (2); handles (3) connected to the curved band (2); and attachment points (4) at both ends of the curved band (2) for connecting to a strap.

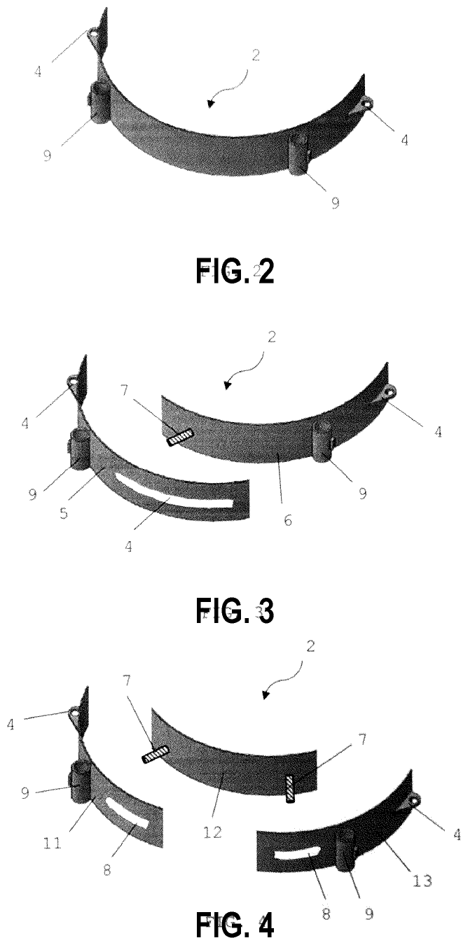

As shown in FIG. 2, the curved band (2) is dimensioned to encircle a portion of the cylindrical body (10). For example, the length or arc of the curved band (2) can be dimensioned to encircle from about a quarter of the circumference of cylindrical body (10) to nearly all of the circumference of the cylindrical body (10). However, a device (1) having a curved band (2) that has a short length or arc will only really be effective in carrying and moving cylindrical bodies (10) with a smaller diameter, such as compressed gas cylinders. If a curved band having a short length (i.e. approximately 25% or less than the circumference of the cylindrical body) were to be used to carry and move a cylindrical body (10) with a diameter approximately equal to the diameter of a typical hot water tank (i.e. between 21-25 inches in diameter), then the system would become unstable as the majority to the cylindrical body (10) would be secured via the flexible strap, instead of the device (1) described herein. Although a device (1) having a curved band (2) that is approximately equal to the circumference of the cylindrical body (10) would provide the most stability, such a device (1) would have to be made specifically for the cylindrical body (10) in which it is meant to carry. Moreover, attaching such a device (1) to the cylindrical body may be more difficult than one which only encircles a portion of the cylindrical body (10). Therefore, it is preferred that the curved band (2) have a length or arc that is substantially semi-circular, so that approximately half the circumference of the cylindrical body being moving is supported by the device (1).

The adaptability of the device (1) to accommodate cylindrical bodies (10) of different diameters can be improved by dividing the curved band (2) into segments. As shown in FIG. 3, the curved band (2) can be divided into two separate segments (5,6). The arc length of the curved band (2) can be adjusted by overlapping the two segments (5,6). In particular, amount of overlap between the two segments (5,6) will be inversely proportional to the arc length of the curved band (2). When the appropriate arc length is reached, a locking mechanism (7) can be engaged to lock the two segments (5,6) together. Various types of locking mechanisms (7) suitable for this purpose would be known to those skilled in the art. For example, as shown in FIGS. 3 and 4, the locking mechanism can be a threaded stem (7) attached to one segment (6) that is inserted through a cut-out (8) provided on the other segment (5), to which a wingnut (not shown) is used compress the two segments (5,6) together and prevent movement of the two segments (5,6) with respect to one another.

In an alternate embodiment, as shown in FIG. 4, the curved band (2) is divided into three segments (11,12,13) to accommodate even larger cylinders, such as commercial hot water tanks. In this case, the two end segments (11,13) are provided with cut-outs (8) and the center segment (12) is provided with two threaded stems (7) that are independently inserted through the cut-outs (8) on the segments (11,13). Once again, in this embodiment of the locking mechanism, wingnuts (not shown) can be threaded onto the threaded stems (7) to compress the segments (11,13) onto center segment (12) to prevent movement of the individual segments with respect to one another.

The device described herein can be made of a rigid material, such as steel, or can be made of a semi-rigid material, such as aluminum, hard plastic, or slightly flexible materials. A device made from a semi-rigid material, i.e. a material that maintains it shape, but can be forced to move slightly from that shape, allows for the device to accommodate cylindrical bodies of slightly varying diameter.

To facilitate the carrying of the cylindrical body (10), two handles (3) are connected to the curved band (2). The handles (3) can be permanently or removably connected to the curved band (2) and are interspaced along the curved band (2) to equally balance the lateral weight of the cylindrical body (10) between the two handles (2). The ability to remove the handles (3) from the curved band (2) can be useful for shipping and storing the device (1), whereas permanently connected handles (3) can avoid the loss of the handles (3) and provide added stability for the device (1).

In those embodiments where the handles (3) are removable from the curved band (2), couplers (9) are provided on curved band (2) to receive the handles (3). The couplers (9) can take many forms so long as they can retain the handles (3) in place when the device is in use and release them when they are no longer need to be connected to the device (1). In one embodiment, shown in FIG. 3, for example, the couplers (9) are tubes that are dimensioned to receive the handles (3). In this embodiment, once the handles (3) are inserted into the couplers (9), a fastener is inserted through the coupler (9) to cause the handle (3) to frictionally engage the coupler (9). For example, a screw can be provided that passes through the coupler (9) and pushes the handle (3) against the coupler (9). Alternatively, the screw or a cotter pin can pass through both the coupler (9) and the handle (3) to hold the handle (3) against the coupler (9). In another non-limiting embodiment, the handles (3) are threaded into the couplers (9) so that the two components are frictionally engaged with one another.

The handles (3) can take many different shapes, so long as they are accessible to the user when it is time to lift and move the cylindrical body (10). For example, the handles (3) can be provided as straight, or substantially straight, rods that extend from the curved band (2) to a point beyond an end of the cylindrical body (10)(see FIG. 6). Handles (3) provided in this manner may be difficult, in some circumstances, for the user to grasp in order to lift and move the cylindrical body (10), since the handles (3) may be resting on the ground. As such, straight handles (3) may be useful in situations when the device (1) can be initially installed on a cylindrical body (10) that is positioned off the ground, such as in a storage facility.

In another embodiment, the handles (3) can be positioned to project away from, and substantially perpendicular to, the curved band (2)(see FIG. 7). Once again, these types of handles (3) are most useful in environments where the cylindrical body (10) can be positioned off the ground for initial installation of the device (1) or when moving gas cylinders. In addition, once installed, the handles (3) of FIG. 7 can be used to prop the cylindrical body (10) off the ground.

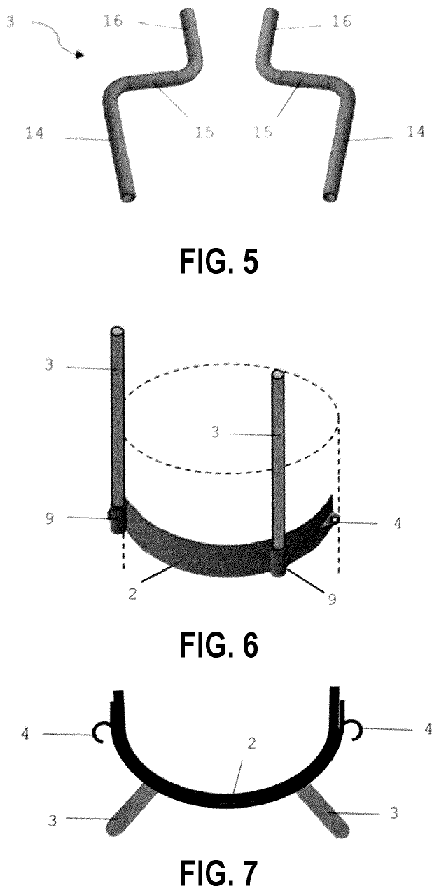

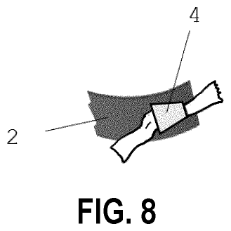

In the preferred embodiment shown in FIGS. 1 and 5, the handles (3) comprise at least a curved band engagement section (14), an intermediate section (15) and a grip section (16). The curved band engagement section (14) is substantially parallel to the grip section (16) and the intermediate section (15) being substantially perpendicular to the curved band engagement section (14) and the grip section (16). It is preferred that the curved band engagement section (14) extends beyond an end of the cylindrical body (10) so that intermediate section (15) is in close proximity, and runs substantially parallel, to the end of the cylindrical body. The intermediate sections (15) can be projected towards the center of the cylindrical body (10). When the handles (3) are provided in this manner, the grip sections (16) are easily accessible by the user, thus avoiding the possibility of fingers being pinched between the cylindrical body (10) and the ground, when the cylindrical body (10) is being lifted from, or placed on, the ground. Moreover, handles (3) provided in this manner distribute the weight of the cylindrical body (10) towards the center the cylindrical body (10) thus making it easier for the user to lift and carry.

In order to improve the comfort of the user, and minimize the possibility that the cylindrical body (10) is dropped during movement thereof, the end of handle (3) that is not connected to the curved band (2) or the grip section (16), can be covered with a material (17) to facilitate grasping of the handle (3) by a user (see FIG. 1). For example, the grip section (16) of the handle (3) can be covered by a rubberized material that can be slightly compressed when the user grasps the handle (3).

Attachment points (4) are provided on the curved band (2) to allow a strap to be connected to the device (1). The attachment points (4) are positioned near or at the ends of the curved band (2). It is preferred that the attachment points (4) are permanently secured to the curved band (2) so that when the strap is tightened around the cylindrical body (10), the attachment points (4) can accommodate the tension and not become detached from the curved band (2). The actual shape and size of the attachment points (4) will depend on the type of connector provided on the ends of the strap. For example, as shown in FIGS. 1-4 and 6, the attachment points (4) can be in the form of eyelets to accommodate straps having hooks (18) on the ends, or some other type of connector than can loop through an eyelet. Alternatively, as shown in FIG. 7, the attachment points (4) can be in the form of hooks to accommodate straps having loop connectors on the ends. In yet a further embodiment, as shown in FIG. 7, the attachment points (4) can be in the form of a ratchet, flip-top or parachute buckle. In the case of a ratchet and flip-top buckle, the ends of the strap are simply passed through the attachment point (4) and the attachment point (4) is engagement to tighten and hold the strap in place. When a parachute buckle is provided, the ends of the strap will be required to include the corresponding portion of the buckle. It should be understood that the two attachment points (4) of the device (1) do not need to be the same, thus allowing straps with different types of ends to be used in conjunction with the device (1) described herein.

In operation, two devices (1) are used to move most cylindrical bodies (10). One device (1) is positioned near one end of the cylindrical body (10) and another device (1) is positioned near the opposite end of the cylindrical body (10). In each case, the device (1) is abutted against the cylindrical body (10) and a strap is attached to each end of the curved band (2) as described above. The strap can be attached to the device (1) either before the device (1) and strap are placed over the cylindrical body (10) or after the device (1) has been positioned against the cylindrical body (10). Once the device (1) and strap encircle the cylindrical body (10), the strap is tightened against the cylindrical body (10) so that movement of the device (1) and the strap along the longitudinal axis of the cylindrical body (10) is eliminated or minimized. The strap can be tightened by providing a ratchet along the length of the strap, or by using an attachment point (4) that can tighten and lock the strap in place. The same process can be done with the second device (1).

To ensure that each device (1) is positioned approximately the same distance away from the ends of the cylindrical body (10), the handles (3) shown in FIGS. 1 and 5 can be used. The intermediate sections (15) can be used to abut against the ends of the cylindrical body (10), thus positioning the devices (1) approximately the same distance away from the ends of the cylindrical body (10).

When using a curved band (2) that can have its length or arc adjusted, the adjustment can occur prior to placement of the device against the cylindrical body (10) or after the device (1) has been positioned against the cylindrical body (10) to ensure a tight fit around the cylinder (10).

Once the devices (1) have been positioned around the cylindrical body (10), two users can grab the handles (3) and lift/move the cylindrical body (10).

Although most cylindrical bodies (10) will require the use of two devices (1) in order to safely move the cylinder (10), it should be understood that a single device (1) and single user could be used to move smaller cylindrical bodies (10).

The components of the device (1) described herein can be provided in a kit. The kit can include the one or more devices (1) described above with or without a corresponding number of straps. A set of instructions for using the device can also be included within the kit.

One or more illustrative embodiments have been disclosed by way of example. It will be understood to persons skilled in the art that a number of variations and modifications can be made without departing from the scope of the invention as defined in the claims.

What is claimed is:

1. A device for assisting in movement of a cylindrical body, the device comprising:
a curved band dimensioned to encircle a portion of the cylindrical body;
two handles connected to the curved band; and
attachment points provided at both ends of the curved band for connecting to a strap.

2. The device of claim 1, wherein each of the two handles comprise at least a curved band engagement section, an intermediate section and a grip section, and wherein the curved band engagement section is substantially parallel to the grip section and the intermediate section is substantially perpendicular to the curved band engagement section and the grip section.

3. The device of claim 2, wherein the curved band engagement section is dimensioned to extend beyond an end of the cylindrical body.

4. The device of claim 2, wherein the intermediate section projects towards the centre of the cylindrical body.

5. The device of claim 2, wherein the grip section is covered with a material to facilitate grasping of the handle by a user.

6. The device of claim 1, wherein each of the two handles projects away from and substantially perpendicular to the curved band.

7. The device of claim 1, wherein the two handles are dimensioned to extend beyond an end of the cylindrical body.

8. The device of claim 1, wherein the two handles are permanently connected to the curved band.

9. The device of claim 1, wherein the two handles are removable from the curved band.

10. The device of claim 9, wherein the curved band further comprises at least two couplers attached thereto for connecting of a corresponding handle.

11. The device of claim 10, wherein the handles are frictionally engaged with the couplers.

12. The device of claim 1, wherein the attachment points are selected from eyelets for receiving hooks associated with the strap, ratchets for receiving the ends of the strap, and hooks for receiving rings associated with the strap.

13. The device of claim 1, wherein the curved band is semi-circular.

14. The device of claim 1, wherein the curved band is made of a semi-rigid material.

15. The device of claim 1, wherein the curved band is segmented to allow for the length or arc of the curved band to be adjusted.

16. The device of claim 15, wherein the curved band comprises three segments and the two end segments move independently with respect to the center segment.

17. The device of claim 15, further comprising a locking mechanism provided on the curved band to prevent movement of the segments with respect to one another.

18. A kit for assisting in movement of a cylindrical body, the kit comprising:
at least one curved band dimensioned to encircle a portion of the cylindrical body, the curved band having attachment points provided at both ends for connecting to a strap; and
at least two handles for connecting to the curved band.

19. The kit of claim 18, further comprising at least one strap for connecting to the attachment points of the curved band.

20. A method of moving a cylindrical body using the device of claim 1, the method comprising the steps of:
abutting a first device against one end of the cylindrical body;
attaching a first strap to the first device so that the first device and first strap encircle the cylindrical body;
tightening the first strap around the cylindrical body;
abutting a second device against the other end of the cylindrical body;
attaching a second strap to the second device so that the second device and second strap encircle the cylindrical body;
tightening the second strap around the cylindrical body;
grasping the handles of the first and second devices; and
lifting the cylindrical body to move the cylindrical body.

21. The method of claim 20, further comprising the step of adjusting the length or arc of the curved band of the first and/or second device to encircle a portion of the cylindrical body prior to abutting the first and/or second device against the cylindrical body.
